(19) United States
(12) Patent Application Publication
(10) Pub. No.: US 2018/0283775 A1
(43) Pub. Date: Oct. 4, 2018

(54) CYROGENIC SEPARATION OF LIGHT OLEFINS AND METHANE FROM SYNGAS

(71) Applicant: SABIC GLOBAL TECHNOLOGIES B.V., Bergen op Zoom (NL)

(72) Inventors: Thabet Al-Qahtani, Riyadh (SA); Khalid Karim, Riyadh (SA); Mubarik Ali Bashir, Riyadh (SA); Ali Al-Hammad, Riyadh (SA)

(21) Appl. No.: 15/763,664

(22) PCT Filed: Sep. 28, 2016
(86) PCT No.: PCT/IB2016/055808

§ 371 Date: Mar. 27, 2018

Related U.S. Application Data
(60) Provisional application No. 62/234,099, filed on Sep. 29, 2015.

(51) Int. Cl. F25J 3/02; C01B 3/50; C10G 2/00

(52) U.S. Cl. CPC F25J 3/0219; C01B 3/506; C10G 2/34; F25J 3/0233; F25J 3/0238; F25J 3/0271; F25J 2270/12; C01B 2203/062; F25J 2200/74; F25J 2205/04; F25J 2210/12; F25J 2270/42; F25J 2270/66; C01B 2203/046

(57) ABSTRACT

In accordance with the present invention, disclosed herein is a method comprising the steps for separating syngas and methane from C2-C4 hydrocarbons. Also disclosed herein, are systems utilized to separate syngas and methane from C2-C4 hydrocarbons.

### CROSS-REFERENCE TO RELATED APPLICATIONS

This Application claims the benefit of U.S. Provisional Application No. 62/234,099, filed Sep. 29, 2015, which is incorporated herein by reference in their entirety.

### BACKGROUND

Syngas (mixtures of H₂ and CO) can be readily produced from either coal or methane (natural gas) by methods well known in the art and widely commercially practiced around the world. A number of well-known industrial processes use syngas for producing various hydrocarbons and oxygenated organic chemicals.

The Fischer-Tropsch catalytic process for catalytically producing hydrocarbons from syngas was initially discovered and developed in the 1920's, and was used in South Africa for many years to produce gasoline range hydrocarbons as automotive fuels. The catalysts typically comprised iron or cobalt supported on alumina or titania, and promoters, like rhenium, zirconium, manganese, and the like were sometimes used with cobalt catalysts, to improve various aspects of catalytic performance. The products were typically gasoline-range hydrocarbon liquids having six or more carbon atoms, along with heavier hydrocarbon products.

Today lower molecular weight C2-C4 hydrocarbons are desired and can be obtained from syngas via the Fischer-Tropsch catalytic process. Challenges exist to efficiently separate unreacted syngas and methane from the lower molecular weight C2-C4 hydrocarbons. Furthermore, to ensure highest yields it is also desirable to recycle unreacted syngas and the separated methane back to the Fischer-Tropsch catalytic process.

Accordingly, there remains a long-term market need for new and improved methods for separation of light olefins and methane from syngas. Still further, there is a need for recycling the separated syngas back to the Fischer-Tropsch catalytic process, and utilizing the separated methane to further generate additional syngas used in the process.

Accordingly, a system and method useful for the separation of C2-C4 hydrocarbons from a produced from syngas are described herein.

### SUMMARY OF THE INVENTION

Disclosed herein is a method comprising the steps of: a) providing a first product stream comprising syngas, methane, and C2-C4 hydrocarbons, wherein the first product stream has a first temperature; b) lowering the first temperature of the first product stream to a second temperature in a first heat exchanger unit; c) separating the first product stream into a syngas stream, a methane stream, and a separated C2-C4 hydrocarbon stream in a cryogenic separation unit, wherein the separated syngas stream has a third temperature, wherein the separated syngas stream comprises at least a first portion and at least a second portion of separated syngas stream, and wherein the separated C2-C4 hydrocarbon stream comprises at least a first portion and at least a second portion of separated C2-C4 hydrocarbon stream; d) lowering the third temperature of the separated syngas stream to a fourth temperature via a N₂ refrigeration loop and a second heat exchange unit; e) recycling energy from the at least a first portion of the separated syngas stream with the fourth temperature to the first product stream comprising syngas, methane, and C2-C4 hydrocarbons via the first heat exchange unit; f) recycling the at least a first portion of the separated syngas stream to a Fischer-Tropsch reactor; and g) recycling the at least a portion of the separated methane stream to a syngas generation unit reactor.

Also disclosed herein is a system comprising: a) a syngas generation unit; b) a Fisher-Tropsch reactor; c) a first, a second, and a third heat exchange unit, wherein at least one of the second and the third exchange units is in communication with the first heat exchange unit; d) a first refrigeration unit; wherein the first refrigeration unit is in communication with the first heat exchange unit; e) a cryogenic separation unit, wherein the cryogenic separation unit is in communication with the Fisher-Tropsch reactor; f) a N₂ refrigeration loop, wherein the N₂ refrigeration loop is in communication with the second heat exchange unit; g) a syngas recovery unit, wherein the syngas recovery unit is in communication with the Fisher-Tropsch reactor; and h) a methane recovery unit, wherein the methane recovery unit is in communication with the syngas generation unit.

Additional advantages will be set forth in part in the description which follows, and in part will be obvious from the description, or can be learned by practice of the aspects described below. The advantages described below will be realized and attained by means of the chemical compositions, methods, and combinations thereof particularly pointed out in the appended claims. It is to be understood that both the foregoing general description and the following detailed description are exemplary and explanatory only and are not restrictive of the invention, as claimed.

### DESCRIPTION OF THE FIGURES

The accompanying figures, which are incorporated in and constitute a part of this specification, illustrate several aspects, and together with the description, serve to explain the principles of the invention.

FIG. 1 shows a flow diagram of a system and a method described herein.

### DETAILED DESCRIPTION

The present invention can be understood more readily by reference to the following detailed description of the invention.

Disclosed herein are materials, compounds, compositions, and components that can be used for, can be used in conjunction with, can be used in preparation for, or are products of the disclosed method and compositions. It is to be understood that when combinations, subsets, interactions, groups, etc. of these materials are disclosed that while specific reference of each various individual and collective combinations and permutation of these compounds cannot be explicitly disclosed, each is specifically contemplated and described herein. This concept applies to all aspects of this disclosure including, but not limited to, steps in methods of making and using the disclosed compositions. Thus, if there are a variety of additional steps that can be performed it is understood that each of these additional steps can be performed with any specific aspect or combination of aspects of the disclosed methods, and that each such combination is specifically contemplated and should be considered disclosed.

All publications mentioned herein are incorporated herein by reference to disclose and describe the methods and/or materials in connection with which the publications are cited.

1. Definitions

In this specification and in the claims which follow, reference will be made to a number of terms which shall be defined to have the following meanings:

As used in the specification and in the claims, the term “comprising” can include the aspects “consisting of” and “consisting essentially of” Unless defined otherwise, all technical and scientific terms used herein have the same meaning as commonly understood by one of ordinary skill in the art to which this invention belongs. In this specification and in the claims, which follow, reference will be made to a number of terms which shall be defined herein.

As used in the specification and the appended claims, the singular forms “a,” “an” and “the” include plural referents unless the context clearly dictates otherwise. Thus, for example, reference to “a hydrocarbon” includes mixtures of two or more hydrocarbons.

As used herein, the terms “about” and “at or about” mean that the amount or value in question can be the value designated some other value approximately or about the same. It is generally understood, as used herein, that it is the nominal value indicated ±10% variation unless otherwise indicated or inferred. The term is intended to convey that similar values promote equivalent results or effects recited in the claims. That is, it is understood that amounts, sizes, formulations, parameters, and other quantities and characteristics are not and need not be exact, but can be approximate and/or larger or smaller, as desired, reflecting tolerances, conversion factors, rounding off, measurement error and the like, and other factors known to those of skill in the art.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed.

The terms “first,” “first product stream,” “first heat exchange unit,” “second,” “second product stream,” “second heat exchange unit,” and the like, where used herein, do not denote any order, quantity, or importance, and are used to distinguish one element from another, unless specifically stated otherwise.

As used herein, the terms “optional” or “optionally” means that the subsequently described event or circumstance can or cannot occur, and that the description includes instances where said event or circumstance occurs and instances where it does not.

References in the specification and concluding claims to parts by weight, of a particular element or component in a composition or article, denote the weight relationship between the element or component and any other elements or components in the composition or article for which a part by weight is expressed. Thus, in a compound containing 2 parts by weight of component X and 5 parts by weight of component Y, X and Y are present at a weight ratio of 2:5, and are present in such a ratio regardless of whether additional components are contained in the compound.

A weight percent (“wt %”) of a component, unless specifically stated to the contrary, is based on the total weight of the formulation or composition in which the component is included. For example, if a particular element or component in a composition or article is said to have about 80% by weight, it is understood that this percentage is relative to a total compositional percentage of 100% by weight.

A mole percent (“mole %”) of a component, unless specifically stated to the contrary, is based on the total number of moles of all chemical components present in the formulation or composition in which the component is included. For example, if a particular element or component in a composition is said to be present in amount about 1 mole %, it is understood that this percentage is relative to a total compositional percentage of 100% by mole.

As used herein, the terms “syngas” or “synthesis gas” are used interchangeably herein.

Moreover, it is to be understood that unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; and the number or type of aspects described in the specification.

2. System

Disclosed herein is a system comprising: a) a syngas generation unit; b) a Fisher-Tropsch reactor; c) a first, a second, and a third heat exchange unit, wherein at least one of the second and the third exchange units is in communication with the first heat exchange unit; d) a first refrigeration unit; wherein the first refrigeration unit is in communication with the first heat exchange unit; e) a cryogenic separation unit, wherein the cryogenic separation unit is in communication with the Fisher-Tropsch reactor; f) a N₂ refrigeration loop, wherein the N₂ refrigeration loop is in communication with the second heat exchange unit; g) a syngas recovery unit, wherein the syngas recovery unit is in communication with the Fisher-Tropsch reactor; and h) a methane recovery unit, wherein the methane recovery unit is in communication with the syngas generation unit.

The syngas generation unit is any unit known in the art capable of generating a synthesis gas (syngas). According to the aspects of this disclosure, the syngas generation unit is in communication with the Fisher-Tropsch reactor and with the methane recovery unit. The Fisher-Tropsch reactor is also in communication with the syngas recovery unit. Isothermal and/or adiabatic fixed bed reactors can be used as a Fischer-Tropsch reactor, which can carry out the Fischer-Tropsch process. The Fischer-Tropsch reactor can comprise one or more Fischer-Tropsch catalysts. Fischer-Tropsch catalysts are known in the art and can, for example, be Fe based catalysts and/or Co based catalysts and/or Ru based catalysts.

In one aspect, the system further comprises a catalytic conversion unit that is in communication with a catalytic conversion unit. A catalytic conversion unit is known in the art and can upgrade hydrocarbons, such as paraffins, to olefins. For example, the catalytic conversion unit can upgrade hydrocarbons present in the first product stream to olefins.

In one aspect, the cryogenic separation unit comprises at least one distillation column. The cryogenic separation unit is used to separate unreacted syngas from methane and other light hydrocarbons and to form a separated syngas stream, a separated methane stream, and separated C2-C4 hydrocarbon stream.

In one aspect, the first heat exchange unit is in communication with the second heat exchange unit. In another aspect, the first heat exchange unit is in communication with the third heat exchange unit. In yet another aspect, the first heat exchange unit is in communication with the second and the third heat exchange units.

In some aspects, the N₂ refrigeration loop comprises a nitrogen refrigeration unit, wherein the nitrogen is a liquid nitrogen. The N₂ refrigeration loop can further comprises pipes, tanks, pumps, valves and any other known in the art articles allowing a flow of nitrogen through the loop.

Optionally, in various aspects, the disclosed system can be operated or configured on an industrial scale. In one aspect, the reactors described herein can each be an industrial size reactor. For example the syngas generation unit can be an industrial size reactor. In yet another example, the Fischer-Tropsch reactor can be an industrial size reactor. For example, the cryogenic separation unit can be an industrial size reactor. In yet other examples, the N₂ refrigeration loop can be an industrial size reactor.

The reactors, units, and vessels disclosed herein can have a volume of at least about 1,000 liters, about 2,000 liters, about 5,000 liters, or about 20,000 liters. For example, the reactor can have a volume from about 1,000 liter to about 20,000 liters.

In one aspect, the syngas generation unit can have a volume of at least about 1,000 liters, about 2,000 liters, about 5,000 liters, or about 20,000 liters. For example, the syngas generation unit can have a volume from about 1,000 liter to about 20,000 liters.

In one aspect, the Fischer-Tropsch reactor can have a volume of at least about 1,000 liters, about 2,000 liters, about 5,000 liters, or about 20,000 liters. For example, the Fischer-Tropsch reactor can have a volume from about 1,000 liter to about 20,000 liters.

In one aspect, the cryogenic separation unit can have a volume of at least about 1,000 liters, about 2,000 liters, about 5,000 liters, or about 20,000 liters. For example, cryogenic separation unit can have a volume from about 1,000 liter to about 20,000 liters.

In one aspect, the N₂ refrigeration loop can have a volume of at least about 1,000 liters, about 2,000 liters, about 5,000 liters, or about 20,000 liters. For example, the methane wash unit can have a volume from about 1,000 liter to about 20,000 liters.

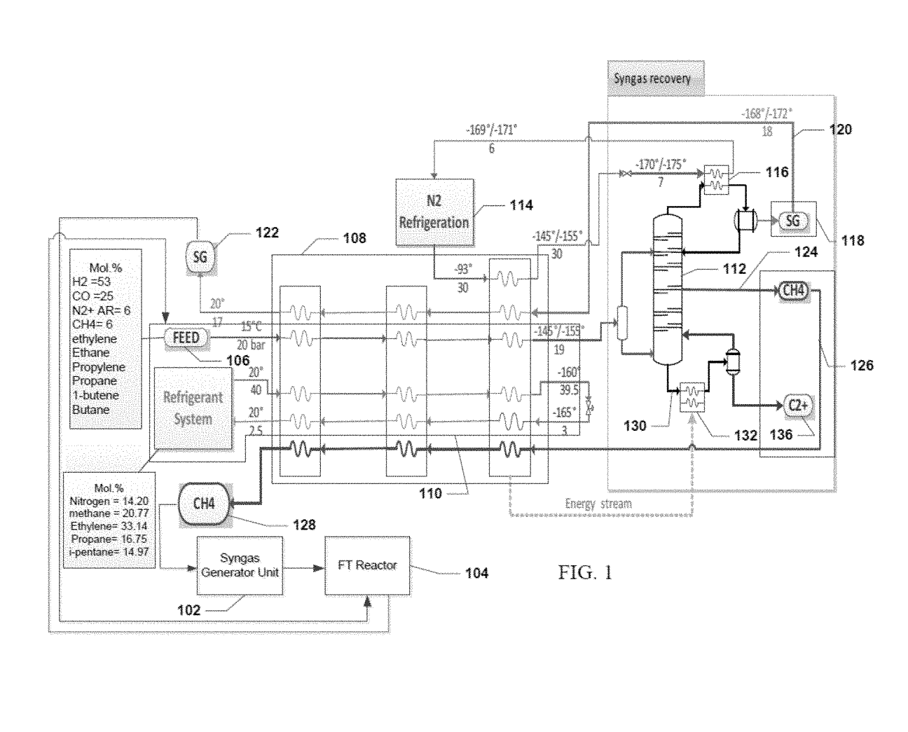

Now referring to FIG. 1, which shows a non-limiting exemplary aspect of the system and method disclosed herein. FIG. 1 shows a system (100). The system has a syngas generation unit (102). The syngas generation unit is in fluid communication with a Fisher-Tropsch reactor (104). The feed (106) comprising a first product stream comprising syngas, methane, and C2-C4 hydrocarbons, and exiting the Fisher-Tropsch reactor (104) is passing through a first heat exchange unit (108). The first heat exchange unit (108) can comprise one or more heat exchange devices (138). A temperature of the first product stream is lowered in the first heat exchange unit (108). The first heat exchange unit (108) is in communication with a first refrigeration unit (110). In some aspects, the first heat exchange unit (108) is in thermal communication with the first refrigeration unit (110). The first product stream is separated in a cryogenic separation unit (112), forming a separated syngas stream, separated methane stream, and separated C2-C4 hydrocarbon stream. The separated syngas stream comprises at least a first portion of separated syngas stream and at least a second portion of separated syngas stream. The separated syngas stream passes through a second heat exchange unit (116) that is in communication with the first heat exchange unit (108). In some aspects, the second heat exchange unit (116) is in thermal communication with the first heat exchange unit (108). The second heat exchange unit (116) is in communication with a nitrogen refrigeration loop (114). In some aspects, the second heat exchange unit (116) is in a thermal communication with a nitrogen refrigeration loop (114). In some aspect, the at least a first portion (118) of the separated syngas stream exiting the cryogenic separation unit (112) is recycled back by means of line (120) through the first heat exchange unit (108) to a syngas recovery unit (122) where it is collected. The syngas recovery unit (122) is in communication with Fisher-Tropsch reactor (104). In some aspects, the at least a second portion of the separated syngas stream is recycled back to the cryogenic separation unit (112). The separated C2-C4 hydrocarbon stream (130) passes through a third heat exchange unit (132) that is in communication with the first heat exchange unit (108). The separated C2-C4 hydrocarbon stream comprises at least a first portion of the separated C2-C4 hydrocarbon stream and at least a second portion of the separated C2-C4 hydrocarbon stream. In some aspects, the at least a first portion of the separated C2-C4 hydrocarbon stream is recycled back to the cryogenic separation unit (112). In other aspects, the at least a second portion of the separated C2-C4 hydrocarbon stream (136) is collected to recover C2-C4 hydrocarbons. In some aspects, the third heat exchange unit (132) is in thermal communication with the first heat exchange unit (108). The separated methane stream (124) is recycled by line (126) to the methane recovery unit (128) that is in communication with the syngas generation unit (102).

3. Methods

Disclosed herein is a method comprising the steps of: a) providing a first product stream comprising syngas, methane, and C2-C4 hydrocarbons, wherein the first product stream has a first temperature; b) lowering the first temperature of the first product stream to a second temperature in a first heat exchanger unit; c) separating the first product stream into a syngas stream, a methane stream, and a C2-C4 hydrocarbon stream in a cryogenic separation unit, wherein the separated syngas stream has a third temperature, wherein the separated syngas stream comprises at least a first portion and at least a second portion of separated syngas stream, and wherein the separated C2-C4 hydrocarbon stream comprises at least a first portion and at least a second portion of separated C2-C4 hydrocarbon stream; d) lowering the third temperature of the separated syngas stream to a fourth temperature via a N₂ refrigeration loop and a second heat exchange unit; e) recycling energy from the at least a first portion of the separated syngas stream with the fourth temperature to the first product stream comprising syngas, methane, and C2-C4 hydrocarbons via the first heat exchange unit; f) recycling the at least a first portion of the separated syngas stream to a Fischer-Tropsch reactor; and g) recycling the at least a portion of the separated methane stream to a syngas generation unit reactor.

In the exemplary aspect, the method disclosed herein is schematically illustrated in FIG. 1. In one aspect, the syngas is generated in a syngas generation unit 102. It is understood that the syngas can be generated from a variety of different materials that contain carbon. In some aspects, the syngas can be generated from biomass, plastics, coal, municipal waste, natural gas, or any combination thereof. In yet other aspects, the syngas can be generated from a fuel comprising methane. In some other aspects, the syngas generation from the fuel comprising methane can be based on steam reforming, autothermal reforming, or a partial oxidation, or any combination thereof In some aspects, the syngas is generated by a steam reforming. In these aspects, steam methane reforming uses an external source of hot gas to heat tubes in which a catalytic reaction takes place that converts steam and methane into a gas comprising hydrogen and carbon monoxide. In other aspects, the syngas is generated by autothermal reforming. In these aspects, methane is partially oxidized in a presence of oxygen and carbon dioxide or steam. In aspects, where oxygen and carbon dioxide are used to generate syngas from methane, the hydrogen and carbon monoxide can be produced in a ratio of 1 to 1. In aspects, where oxygen and steam are utilized, the hydrogen and carbon monoxide can be produced in a ratio of 2.5 to 1. In some aspects, the syngas is generated by a partial oxidation. In these aspects, a substoichiometric fuel-air mixture is partially combusted in a reformer, creating a hydrogen-rich syngas. In certain aspect, the partial oxidation can comprise a thermal partial oxidation and catalytic partial oxidation. In some aspects, the thermal partial oxidation is dependent on the air-fuel ration and proceed at temperatures of 1,200° C. or higher. In yet other aspects, in the catalytic partial oxidation use of a catalyst allows reduction of the required temperature to about 800° C. to 900° C. It is further understood that the choice of reforming technique can depend on the sulfur content of the fuel being used. The catalytic partial oxidation can be employed if the sulfur content is below 50 ppm. A higher sulfur content can poison the catalyst, and thus, other reforming techniques can be utilized.

In certain aspects, the syngas generated in the syngas generation unit 102 enters a Fischer-Tropsch reactor 104 wherein the desired hydrocarbons are catalytically produced. It is understood that the first product stream described in the aspects of this disclosure if formed in the Fisher-Tropsch reactor 104. The Fischer-Tropsch catalytic process for producing hydrocarbons from syngas is known in the art. Several reactions can take place in a Fischer-Tropsch process, such as, a Fischer-Tropsch (FT) reaction, a water gas shift reaction, and a hydrogen methanation, as shown in Scheme 1.

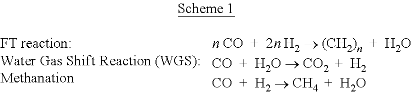

It is understood that the composition of syngas entering a Fischer-Tropsch reactor can vary significantly depending on the feedstock and the gasification process involved. In some aspects, the syngas composition can comprise from about 25 to about 60 wt. % carbon monoxide (CO), about 15 to about 50 wt. % hydrogen (H₂), from 0 to about 25 wt. % methane (CH₄), and from about 5 to about 45 wt. % carbon dioxide (CO₂). In yet other aspects, the syngas can further comprise nitrogen gas, water vapor, sulfur compounds such as for example, hydrogen sulfide (H₂S) and carbonyl sulfide (COS). In yet other aspects, the syngas can further comprise ammonia and other trace contaminants.

The main gases that are being mixed in the Fischer-Tropsch process described herein comprise H₂ and CO. In some aspects, the H₂/CO molar ratio of the feed can be from about 0.5 to about 4. In some exemplary aspects, the H₂/CO molar ratio can be from about 1.0 to about 3.0. In other exemplary aspects, the H₂/CO molar ratio can be from about 1.5 to about 3.0, or yet further exemplary aspects, the H₂/CO molar ratio can be from about 1.5 to about 2.5. It will be appreciated that the H₂/CO molar ratio can control the selectivity of the hydrocarbons that are being produced. The consumption molar ratio of H₂/CO is usually from about 1.0 to about 2.5, such as for example, from about 1.5 to 2.1. This ratio increases as long as the water gas shift reaction is active, and thus, the use of a feed ratio below the consumption ratio will result in a stable H₂/CO ratio during the reaction within an acceptable range (normally below about 2). The H₂ and CO are catalytically reacted in a Fischer-Tropsch reaction.

A Fischer-Tropsch process that targets the production of light olefins (C2-C6 olefins) is desired and such process can produce a significant amount of C2-C4 hydrocarbons. In some aspects, the feed exiting from the Fischer-Tropsch reactor comprises a first product stream 106. In some aspects, the first product stream comprises syngas, methane, and C2-C4 hydrocarbons. In some exemplary aspects, the first product stream can comprise hydrogen, carbon monoxide, methane, ethylene, ethane, propylene, propane, butenes, butane, mixture of nitrogen and argon, C5-C7 hydrocarbons, or any combination thereof. It is understood that all components present in the first product stream can be in any ratio relatively to each other. This first product stream is further processed to separate methane and C2-C4 hydrocarbons from the unreacted syngas. An exemplary non-limiting composition of the first product steam is shown in Table 1. The values shown in Table 1 were simulated using Aspen HYSYS V8.4. The values in Table 1 of the first product stream were calculated after removal of CO₂ and upgrade of C4-C9 hydrocarbons (olefins) via a catalytic conversion unit before being integrated with the remainder of the system disclosed herein.

TABLE 1

| First Product Stream Components | Wt. % |
|---|---|
| CO | 40-55 |
| H₂ | 8-12 |
| Methane | 7-11 |
| C2-C7 Olefins/paraffin's | 21-30 |

In some aspects, the first product stream has a first temperature. In certain aspect, the first temperature is in the range from about 10° C. to about 50° C., including exemplary values of about 15° C., about 20° C., about 25° C., about 30° C., about 35° C., about 40° C., and about 45° C. Still further, the first temperature can be in any range derived from any two of the above stated values. For example, the first product stream can have a first temperature in the range from about 15° C. to about 40° C., or from about 20° C. to about 50° C.

In certain aspects, the first product stream can have a first pressure. In one aspect, the first pressure is in the range from about 1 bar to about 70 bar, including exemplary values of about 5 bar, about 10 bar, about 15 bar, about 20 bar, about 25 bar, about 30 bar, about 35 bar, about 40 bar, about 50 bar, about 55 bar, about 60 bar, and about 65 bar. Still further, the first pressure can be in any range derived from any two of the above stated values. For example, the first product stream can have a first pressure in the range from about 20 bar to about 50 bar, or from about 40 bar to about 65 bar.

In further aspects, the first temperature of the first product stream can be lowered to a second temperature in a first heat exchange unit 108. In some aspects, the second temperature is in the range from about −120° C. to about −170° C., including exemplary values of about −125° C., about −130° C., about −135° C., about −140° C., about −145° C., about −150° C., about −155° C., about −160° C., and about −165° C. Still further, the second temperature can be in any range derived from any two of the above stated values. For example, the second temperature can be in the range from about −130° C. to about −155° C., or from about −145° C. to about −160° C.

The heat exchange units are known in the art. In some aspects, the first heat exchange unit can comprise one or more heat exchange devices 138. In other aspects, the first heat exchange unit can comprise at least two heat exchange devices. It is further understood that the term “heat exchange device,” as used herein, refers to any device built for efficient heat transfer from one medium to another. In some aspects, the media can be separated by a solid wall to prevent mixing. In other aspects, the media can be in direct contact. It is understood that any known in the art heat exchange devices can be used in the method disclosed herein.

It is further understood that the heat exchange devices can be classified according to their flow arrangements. In the aspects, where two fluids enter the exchanger at the same end, and travel in parallel to one another to the other side, the heat exchange device is classified as parallel-flow heat exchanger. In the aspects, where two fluids enter the exchanger from opposite ends is classified as a counter-flow heat exchanger. In the aspects, wherein two fluids travel perpendicular to one another through the exchange, the heat exchange device is classified as a cross-flow heat exchanger. It is understood that the first heat exchange unit can comprise one or more of a parallel-flow heat exchange device, a counter-flow heat exchange device, or a cross-flow heat exchange device, or any combinations thereof. In some aspects, the first heat exchange unit is one or more of a parallel-flow heat exchange device. In another aspect, the first heat exchange unit is one or more of a counter-flow heat exchange device. In a yet further aspect, the first heat exchange unit is one or more of a cross-flow heat exchange device.

In some aspects, to accelerate the heat exchange process, the first heat exchange unit can be in communication with a first refrigeration system 110. The first refrigeration system can comprise a variety of gases. In some aspects, the first refrigeration system can comprise nitrogen, methane, ethylene, propane, pentane or any combinations thereof

In certain aspects, the first product stream existing the first heat exchange unit at the second temperature enters a cryogenic separation unit 112 to form a separated syngas stream, a separated methane stream, and a separated C2-C4 hydrocarbon stream. Cryogenic separation units are known in the art. In some aspects, the cryogenic separation comprises at least one distillation column. A non-limiting example of a cryogenic separation unit is described in published US application 2009/0205367 to Price, which is incorporated in its entirety by reference herein, particularly for its disclosure related to cryogenic separation units.

In some aspects, at least a portion of the separated syngas exiting the cryogenic separation unit has a temperature from about −165° C. to about −180° C., including exemplary values of −169° C. The separated syngas stream passes through a second heat exchange unit 116 that is in thermal communication with nitrogen refrigeration loop 114. Nitrogen refrigeration loop 114 provides a flow of a liquid nitrogen having a temperature in the range from about −160° C. to about −200° C., including exemplary values of about −170° C., about −175° C., about −180° C., about −185° C., about −190° C. and about −195° C. Still further, the temperature can be in any range derived from any two of the above stated values. For example, the flow of liquid nitrogen in the nitrogen refrigeration loop can be from about −165° C. to about −180° C., or from about −170° C. to about −175° C.

In some aspects, the flow of a liquid nitrogen from the nitrogen refrigeration loop 114 enters the second heat exchange unit 116 in a parallel flow with the at least a portion of the separated syngas. In some aspects, the flow of a liquid nitrogen enters the second heat exchange unit in a counter-flow with the at least a portion of the separated syngas. It is further understood that the third temperature of the separated syngas stream entering the second heat exchange unit 116 is lowered by the heat exchange with the nitrogen refrigeration loop 114; thereby lowering the third temperature to a fourth temperature. It is further understood that the second heat exchange unit 116 can comprise one or more of a parallel-flow heat exchange device, a counter-flow heat exchange device, a cross-flow heat exchange device, or any combination thereof

The nitrogen refrigeration loops are known in the art. The nitrogen refrigeration loop can comprise pipes, tanks, valves, pumps, or any other known in the art articles and means that allow flow of a liquid nitrogen through the loop to further lower the temperature of a desired gas flow. A non-limiting example of a nitrogen refrigeration loop unit is described in U.S. Pat. No. 6,298,688 to Brostow, which is incorporated in its entirety by reference herein, particularly for its disclosure related to nitrogen refrigeration loops.

In some aspects, the fourth temperature is the range of −150° C. to about −200° C., including exemplary values of about −151° C., about −152° C., about −153° C., about −154° C., about −155° C., about −156° C., about −157° C., about −158° C., about −159° C., about −160° C., about −161° C., about −162° C., about −163° C., about −164° C., about −165° C., about −166° C., about −167° C., about −168° C., about −169° C., about −170° C., about −171° C., about −172° C., about −173° C., about −174° C., about −175° C., about −176° C., about −177° C., about −178° C., about −179° C., about −180° C., about −181° C., about −182° C., about −183° C., about −184° C., about −185° C., about −186° C., about −187° C., about −188° C., about −189° C., about −190° C., about −191° C., about −192° C., about −193° C., about −194° C., about −195° C., about −196° C., about −197° C., about −198° C., and about −199° C. Still further, the temperature can be in any range derived from any two of the above stated values. For example, the separated syngas stream exiting the second heat exchange unit can have a temperature in the range from about −155° C. to about −190° C., or from about −168° C. to about −172° C., or from about −170° C. to about −195° C.

In some aspect the separated syngas stream exiting the second heat exchange unit can comprise at least a first portion of the separated syngas stream and at least a second portion of the separated syngas stream.

In some aspects, the second heat exchange unit is in communication with the first heat exchange unit to allow energy recycling within the process. In certain aspects, the second heat exchange unit is in thermal communication with the first heat exchange unit. In one aspect, the at least a first portion of the separated syngas stream is further recycled back to a Fischer-Tropsch reactor 104. In certain aspects, the recycling comprises passing of the at least a first portion of separated syngas stream 118 utilizing line 120 through the first heat exchange unit 108. In some aspects, the first heat exchange device of the first heat exchange unit that the at least a first portion of the separated syngas stream enters is the least heat exchange device of the first heat exchange unit that the first product stream passes through. In certain aspects, a flow of the first product stream in the first heat exchange unit is counter-flow to a flow of the at least a first portion of the separated syngas stream. In certain aspects, the passing of the at least a first portion of the separated syngas stream through the first heat exchange unit transfers a heat released by the first product stream to the at least a first portion of the separated syngas stream. It is understood that the passing through the first heat exchange unit, a temperature of the at least a first portion of the separated syngas stream rises due to the heat exchange with the first product stream. In some aspects, the at least a first portion of the separated syngas stream collected in the syngas recovery unit 122, after the exit from the first heat exchange unit has a temperature in the range from about 10° C. to about 50° C., including exemplary values of about 15° C., about 20° C., about 25° C., about 30° C., about 35° C., about 40° C., and about 45° C. Still further, the temperature can be in any range derived from any two of the above stated values. For example, the temperature of the at least a first portion of the separated syngas stream collected on the exit from the first heat exchange unit can be about 15° C. to about 40° C., or from about 20° C. to about 50° C.

In yet another aspect, the at least a second portion of the separated syngas stream can be returned back to the cryogenic separation unit 112 to provide auxiliary reflux.

According to the aspects disclosed herein, the separated C2-C4 hydrocarbon stream 130 passes through a third heat exchange unit 132 to reach a temperature in the range from about −70° C. to about −150° C., including exemplary values of about −75° C., about −80° C., about −85° C., about −90° C., about −95° C., about −100° C., about −105° C., about −110° C., about −115° C., about −120° C., about −125° C., about −130° C., about −135° C., about −140° C., and about −145° C. Still further, the temperature can be in any range derived from any two of the above stated values. For example, the temperature of the separated C2-C4 hydrocarbon stream collected at the exit from the third heat exchange 132 unit can be about −75° C. to about −85° C., or from about −80° C. to about −95° C., or from about −100° C. to about −110° C. In certain aspects, the third heat exchange unit 132 is in communication with the first heat exchange unit 108. In other aspects, the third heat exchange unit is in thermal communication with the first heat exchange unit 108. It is further understood that the third heat exchange unit can be in communication with one or more heat exchange devices present in the first heat exchange unit. It is further understood that the third heat exchange unit can comprise one or more of a parallel-flow heat exchange device, a counter-flow heat exchange device, a cross-flow heat exchange device, or any combination thereof. In some aspects, the separated C2-C4 hydrocarbon stream exiting the third heat exchange unit can comprise at least a first portion of the separated C2-C4 hydrocarbon stream and at least a second portion of the separated C2-C4 hydrocarbon stream. In some aspects, the at least a first portion of the separated C2-C4 hydrocarbon stream is returned to the bottom of the cryogenic separation unit 112. At least a portion of the separated C2-C4 hydrocarbon stream is returned to the bottom of the cryogenic separation unit (112) to be reheated to separate residual syngas, which is used to drive the distillation function of and C2-C4 hydrocarbon recovery (separated C2-C4 hydrocarbon stream).

According to further aspects of this disclosure, the at least a second portion of the separated C2-C4 hydrocarbon stream 136 is collected to recover C2-C4 hydrocarbons. In yet other aspects, the second portion of the separated C2-C4 hydrocarbon stream is transferred for further separation of ethylene, ethane, propylene, or propane, or a combination thereof

In certain aspects, the process described herein further comprises separating ethylene, ethane, propylene, or propane, or a combination thereof from the at least a second portion of the Separated C2-C4 hydrocarbon stream. It is understood that any separation methods known in the art can be employed. For example and without limitation, deethanizers or depropanizers can be employed for the olefin separation.

In some aspects, the yield of C2-C4 hydrocarbon recovery is from about 80% to about 100%, including exemplary values of about 85%, about 90%, about 95%, about 98%, about 99%, about 99.5%, and about 99.9%.

In some aspects, the separated methane stream 124 exiting the cryogenic separation unit 112 is transferred by means of line 126 through the first heat exchange unit thereby transferring a heat released by the first product stream to the separated methane stream. The separated methane stream collected in a methane recovery unit 128 is further transferred to a syngas generation unit 102. It is understood that the recycling of the separated methane stream to the syngas generation unit 102 and the at least a first portion of the separated syngas stream to the Fisher-Tropsch reactor 104 allows a continued loop of producing desirable olefins while minimizing waste and increasing yield and efficiency.

In other aspects, the third product stream can comprise at least a first portion of the third product stream and at least a second portion of the third product stream. In certain aspects, the at least a first portion of the third product stream is transferred for further separation of ethylene, ethane, propylene, or propane.

4. Aspects

In view of the described catalyst and catalyst compositions and methods and variations thereof, herein below are described certain more particularly described aspects of the inventions. These particularly recited aspects should not however be interpreted to have any limiting effect on any different claims containing different or more general teachings described herein, or that the “particular” aspects are somehow limited in some way other than the inherent meanings of the language and formulas literally used therein.

Aspect 1: A method comprising the steps of: a) providing a first product stream comprising syngas, methane, and C2-C4 hydrocarbons, wherein the first product stream has a first temperature; b) lowering the first temperature of the first product stream to a second temperature in a first heat exchanger unit; c) separating the first product stream into a syngas stream, a methane stream, and a C2-C4 hydrocarbon stream in a cryogenic separation unit, wherein the separated syngas stream has a third temperature, wherein the separated syngas stream comprises at least a first portion and at least a second portion of separated syngas stream, and wherein the separated C2-C4 hydrocarbon stream comprises at least a first portion and at least a second portion of separated C2-C4 hydrocarbon stream; d) lowering the third temperature of the separated syngas stream to a fourth temperature via a N₂ refrigeration loop and a second heat exchange unit; e) recycling energy from the at least a first portion of the separated syngas stream with the fourth temperature to the first product stream comprising syngas, methane, and C2-C4 hydrocarbons via the first heat exchange unit; f) recycling the at least a first portion of the separated syngas stream to a Fischer-Tropsch reactor; and g) recycling the at least a portion of the methane stream to a syngas generation unit reactor.

Aspect 2: The method of aspect 1, wherein the first temperature is in the range from about 10° C. to about 50° C.

Aspect 3: The method of aspects 1 or 2, wherein the first product stream has a first pressure in the range from about 20 bar to about 50 bar.

Aspect 4: The method of any one of aspects 1-3, wherein the second temperature is in the range from about −120° C. to about −170° C.

Aspect 5: The method of any one of aspects 1-4, wherein the first heat exchange unit is in communication with a first refrigeration system.

Aspect 6: The method of any one of aspects 1-5, wherein the first heat exchange unit comprises one or more heat exchange devices.

Aspect 7: The method of any one of aspects 1-6, wherein the first heat exchange unit comprises at least two heat exchange devices.

Aspect 8: The method of any one of aspects 1-7, wherein the third temperature is in the range of −150° C. to about −160° C.

Aspect 9: The method of any one of aspects 1-8, wherein the fourth temperature is in the range of about −150° C. to about −185° C.

Aspect 10: The method of any one of aspects 1-9, wherein the second heat exchange unit is in communication with the first heat exchange unit.

Aspect 11: The method of any one of aspects 1-10, wherein recycling energy from the separated syngas stream with the fourth temperature comprises passing the at least a first portion of the separated syngas stream through the first heat exchange unit thereby transferring a heat released by the first product stream to the at least a first portion of the separated syngas stream; thereby also lowering the temperature of the first product stream.

Aspect 12: The method of any one of aspects 1-11, wherein after passing the at least a first portion of the separated syngas stream through the first heat exchange unit, a temperature of the at least a first portion of the separated syngas stream is in the range of about 10° C. to about 50° C.

Aspect 13: The method of any one of aspects 1-12, wherein a flow of the first product stream in the first heat exchange unit is counter-flow to a flow of the at least a first portion of the separated syngas stream being recycled to the Fisher-Tropsch reactor.

Aspect 14: The method of any one of aspects 1-13, wherein the separated methane stream passes through the first heat exchange unit thereby transferring a heat released by the first product to the separated methane stream.

Aspect 15: The method of aspect 14, wherein a flow of the first product stream in the first heat exchange unit is counter-flow to a flow of the separated methane stream.

Aspect 16: The method of any one of aspects 1-15, wherein the separated C2-C4 hydrocarbon stream exiting the cryogenic separation unit passes through a third heat exchange unit.

Aspect 17: The method of aspect 16, wherein the third heat exchange unit is in communication with the first heat exchange unit.

Aspect 18: The method of any one of aspects 16-17, further comprising separating ethylene, ethane, propylene, or propane, or a combination thereof from the at least a first portion of the separated C2-C4 hydrocarbon stream.

Aspect 19: A system comprising: a) a syngas generation unit; b) a Fisher-Tropsch reactor; c) a first, a second, and a third heat exchange unit, wherein at least one of the second and the third exchange units is in communication with the first heat exchange unit; d) a first refrigeration unit; wherein the first refrigeration unit is in communication with the first heat exchange unit; e) a cryogenic separation unit, wherein the cryogenic separation unit is in communication with the Fisher-Tropsch reactor; f) a N₂ refrigeration loop, wherein the N₂ refrigeration loop is in communication with the second heat exchange unit; g) a syngas recovery unit, wherein the syngas recovery unit is in communication with the Fisher-Tropsch reactor; and h) a methane recovery unit, wherein the methane recovery unit is in communication with the syngas generation unit.

Aspect 20: The method of aspect 19, wherein the syngas generation unit is in communication with the Fisher-Tropsch reactor.

1. A method comprising the steps of:
a) providing a first product stream comprising syngas, methane, and C2-C4 hydrocarbons, wherein the first product stream has a first temperature;
b) lowering the first temperature of the first product stream to a second temperature in a first heat exchanger unit;
c) separating the first product stream into a syngas stream, a methane stream, and a C2-C4 hydrocarbon stream in a cryogenic separation unit, wherein the separated syngas stream has a third temperature, wherein the separated syngas stream comprises at least a first portion and at least a second portion of separated syngas stream, and wherein the separated C2-C4 hydrocarbon stream comprises at least a first portion and at least a second portion of separated C2-C4 hydrocarbon stream;
d) lowering the third temperature of the separated syngas stream to a fourth temperature via a N₂ refrigeration loop and a second heat exchange unit;
e) recycling energy of the at least a first portion of the separated syngas stream with the fourth temperature to the first product stream comprising syngas, methane, and C2-C4 hydrocarbons via the first heat exchange unit;
f) recycling at least a first portion of the separated syngas stream to a Fischer-Tropsch reactor; and
g) recycling at least a portion of the separated methane stream to a syngas generation unit reactor.

2. The method of claim 1, wherein the first temperature is in the range from about 10° C. to about 50° C.

3. The method of claim 1, wherein the first product stream has a first pressure in the range from about 20 bar to about 50 bar.

4. The method of claim 1, wherein the second temperature is in the range from about -120° C. to about -170° C.

5. The method of claim 1, wherein the first heat exchange unit is in communication with a first refrigeration system.

6. The method of claim 1, wherein the first heat exchange unit comprises one or more heat exchange devices.

7. The method of claim 1, wherein the first heat exchange unit comprises at least two heat exchange devices.

8. The method of claim 1, wherein the third temperature is in the range of −150° C. to about −160° C.

9. The method of claim 1, wherein the fourth temperature is in the range of about −150° C. to about −200° C.

10. The method of claim 1, wherein the second heat exchange unit is in communication with the first heat exchange unit.

11. The method of claim 1, wherein recycling energy from the separated syngas stream with the fourth temperature comprises passing the at least a first portion of the separated syngas stream through the first heat exchange unit thereby transferring a heat released by the first product stream to the at least a first portion of the separated syngas stream; thereby also lowering the temperature of the first product stream.

12. The method of claim 1, wherein after passing the at least a first portion of the separated syngas stream through the first heat exchange unit, a temperature of the at least a first portion of the separated syngas stream is in the range of about 10° C. to about 50° C.

13. The method of claim 1, wherein a flow of the first product stream in the first heat exchange unit is counter-flow to a flow of the at least a first portion of the separated syngas stream being recycled to the Fisher-Tropsch reactor.

14. The method of claim 1, wherein the separated methane stream passes through the first heat exchange unit thereby transferring a heat released by the first product to the separated methane stream.

15. The method of claim 14, wherein a flow of the first product stream in the first heat exchange unit is counter-flow to a flow of the separated methane stream.

16. The method of claim 1, wherein the separated C2-C4 hydrocarbon stream exiting the cryogenic separation unit passes through a third heat exchange unit.

17. The method of claim 16, wherein the third heat exchange unit is in communication with the first heat exchange unit.

18. The method of claim 16, further comprising separating ethylene, ethane, propylene, or propane, or a combination thereof from the at least a first portion of the separated C2-C4 hydrocarbon stream.

19. A system comprising:
a) a syngas generation unit;
b) a Fisher-Tropsch reactor;
c) a first, a second, and a third heat exchange unit, wherein at least one of the second and the third exchange units is in communication with the first heat exchange unit;
d) a first refrigeration unit, wherein the first refrigeration unit is in communication with the first heat exchange unit;
e) a cryogenic separation unit, wherein the cryogenic separation unit is in communication with the Fisher-Tropsch reactor;
f) a N₂ refrigeration loop, wherein the N₂ refrigeration loop is in communication with the second heat exchange unit;
g) a syngas recovery unit, wherein the syngas recovery unit is in communication with the Fisher-Tropsch reactor; and
h) a methane recovery unit, wherein the methane recovery unit is in communication with the syngas generation unit.

20. The method of claim 19, wherein the syngas generation unit is in communication with the Fisher-Tropsch reactor.
